(19) United States
(12) Patent Application Publication
(10) Pub. No.: US 2023/0306301 A1
(43) Pub. Date: Sep. 28, 2023

(54) DAMAGE RATE CURVE CREATION METHOD, DAMAGE RATE CURVE CREATION DEVICE, AND PROGRAM

(71) Applicant: NIPPON TELEGRAPH AND TELEPHONE CORPORATION, Chiyoda-ku, Tokyo (JP)

(72) Inventors: Akira ITO, Musashino-shi, Tokyo (JP); Masaru OKUTSU, Musashino-shi, Tokyo (JP)

(73) Assignee: NIPPON TELEGRAPH AND TELEPHONE CORPORATION, Chiyoda-ku, Tokyo (JP)

(21) Appl. No.: 18/002,862

(22) PCT Filed: Jul. 15, 2020
(86) PCT No.: PCT/JP2020/027517

§ 371 Date: Dec. 22, 2022

(51) Int. Cl. G06N 20/00

(52) U.S. Cl. CPC G06N 20/00

(57) ABSTRACT

A damage rate curve creation method includes: creating machine learning models predicting and outputting a first damage rate of a pipeline for each pipeline characteristic from first pipeline damage data including information of earthquake damage and pipeline characteristics; extracting a feature amount having high contribution to the prediction for each of the models; analyzing a change in the first damage rate related to a change in the feature amount; specifying a value of the feature amount at an inflection point of the change in the first damage rate as an extreme value, and extracting, from the first pipeline damage data, data having a value of the feature amount at which a difference from the extreme value is equal to or less than a threshold value as second pipeline damage data; and creating a damage rate curve indicating a second damage rate based on the second pipeline damage data.

### TECHNICAL FIELD

The present disclosure relates to a damage rate curve creation method, a damage rate curve creation device, and a program.

### BACKGROUND ART

A method for predicting a damage rate of a pipeline disposed under the ground caused by an earthquake is being studied.

With regard to the prediction of the damage rate, an earthquake motion index to be used has been conventionally determined by experience, simple statistics, or the like. For example, Non Patent Literature 1 describes a formula for predicting pipeline damage as a method for predicting a damage rate of a water pipe. This formula obtains an estimated damage rate by multiplying a standard damage rate curve by correction coefficients of the pipe type, the diameter, and the microtopography. The standard damage rate curve is constructed by use of a peak ground velocity (PGV), which is the maximum velocity on the ground surface, in a place without liquefaction. Non Patent Literature 2 describes a method for determining whether to stop gas supply for a low-pressure gas conduit by use of a spectral intensity (SI) value. Meanwhile, an earthquake motion index different from the PGV or SI value is proposed, and for example, Non Patent Literature 3 describes using PGV²/PGA. In addition, Non Patent Literature 4 suggests that an index of an earthquake motion affecting the occurrence of damage may be different depending on the pipe type of a communication buried pipe.

### CITATION LIST

### Non Patent Literature

Non Patent Literature 1: Public Interest Incorporated Foundation Japan Water Research Center, “Study on Review of “Formula for Predicting Pipeline Damage due to Earthquake” based on 2016 Kumamoto earthquakes”, 2016
Non Patent Literature 2: Eight-Japan Engineering Consultants Inc., “Business Report on Optimization of Criterion for Determination to Stop Supply of City Gas”, 2018
Non Patent Literature 3: Omar Pineda-Porras, “A New Seismic Intensity Parameter to Estimate Damage in Buried Pipelines due to Seismic Wave Propagation”, Journal of Earthquake Engineering, 11, pp. 773-786 (2007)
Non Patent Literature 4: Yo Ito and four others, “Damage Analysis of Rigid PVC Pipe and Steel Pipe for Communication”, 39th JSCE Earthquake Engineering Symposium, C21-1482, 2019

### SUMMARY OF INVENTION

### Technical Problem

However, there is room for improvement in accuracy in the prediction of a damage rate of a pipeline. In the conventional technologies, the type of pipeline is not considered in determining the earthquake motion index to be used for predicting the damage rate. In addition, if a normal statistical method is applied, there is a possibility that the accuracy in setting of a threshold value at which the damage rate starts to increase may be insufficient. There has been a demand for a method capable of more accurately predicting the damage rate by flexibly changing the earthquake motion index to be used for the prediction depending on the type of pipeline and appropriately setting the threshold value at which the damage rate starts to increase.

An object of the present disclosure made in view of such circumstances is to provide a method for more accurately predicting a damage rate of a pipeline.

### Solution to Problem

In order to solve the above-described problem, a damage rate curve creation method according to the present disclosure includes: a step of creating a plurality of machine learning models that predict and output a first damage rate of a pipeline for each pipeline characteristic by use of first pipeline damage data including information on presence or absence of earthquake damage and pipeline characteristics; a step of extracting a feature amount having high contribution to the prediction for each of the machine learning models; a step of analyzing a change in the first damage rate related to a change in the feature amount; a step of specifying a value of the feature amount at an inflection point of the change in the first damage rate as an extreme value, and extracting, from the first pipeline damage data, data having a value of the feature amount at which a difference from the extreme value is equal to or less than a threshold value as second pipeline damage data; and a step of creating a damage rate curve indicating a second damage rate based on the second pipeline damage data.

In addition, a damage rate curve creation device according to the present disclosure includes: a model creation unit configured to create a plurality of machine learning models that predict and output a first damage rate of a pipeline for each pipeline characteristic by use of first pipeline damage data including information on presence or absence of earthquake damage and pipeline characteristics; a feature amount extraction unit configured to extract a feature amount having high contribution to the prediction for each of the machine learning models; a prediction analysis unit configured to analyze a change in the first damage rate related to a change in the feature amount; a data extraction unit configured to specify a value of the feature amount at an inflection point of the change in the first damage rate as an extreme value, and extract, from the first pipeline damage data, data having a value of the feature amount at which a difference from the extreme value is equal to or less than a threshold value as second pipeline damage data; and a curve creation unit configured to create a damage rate curve indicating a second damage rate based on the second pipeline damage data.

In addition, a program according to the present disclosure causes a computer to function as the damage rate curve creation device.

### Advantageous Effects of Invention

According to a damage rate curve creation method, a damage rate curve creation device, and a program according to the present disclosure, it is possible to provide a method for more accurately predicting a damage rate of a pipeline.

### BRIEF DESCRIPTION OF DRAWINGS

FIG. 1 is a diagram illustrating a schematic configuration of a system according to a first embodiment of the present disclosure.

FIG. 2 is a diagram illustrating an example of a configuration of a damage rate curve creation device according to the first embodiment of the present disclosure.

FIG. 3A is a diagram illustrating an example of a table stored in a past seismic pipeline damage database according to the first embodiment of the present disclosure.

FIG. 3B is a diagram illustrating the example of the table stored in the past seismic pipeline damage database according to the first embodiment of the present disclosure.

FIG. 4 is a diagram illustrating an example of a configuration of a damage rate curve application device according to the first embodiment of the present disclosure.

FIG. 5A is a diagram illustrating an example of a table stored in an estimation target pipeline database according to the first embodiment of the present disclosure.

FIG. 5B is a diagram illustrating the example of the table stored in the estimation target pipeline database according to the first embodiment of the present disclosure.

FIG. 6A is a flowchart illustrating an example of operation of the damage rate curve creation device according to the first embodiment of the present disclosure.

FIG. 6B is a flowchart illustrating the example of the operation of the damage rate curve creation device according to the first embodiment of the present disclosure.

FIG. 7 is a diagram illustrating an application example of the damage rate curve creation device according to the first embodiment of the present disclosure.

FIG. 8 is a diagram illustrating an application example of the damage rate curve creation device according to the first embodiment of the present disclosure.

FIG. 9 is a diagram illustrating an application example of the damage rate curve creation device according to the first embodiment of the present disclosure.

FIG. 10 is a diagram illustrating an application example of the damage rate curve creation device according to the first embodiment of the present disclosure.

FIG. 11 is a flowchart illustrating an example of operation of the damage rate curve application device according to the first embodiment of the present disclosure.

FIG. 12A is a diagram illustrating an application example of the damage rate curve application device according to the first embodiment of the present disclosure.

FIG. 12B is a diagram illustrating an application example of the damage rate curve application device according to the first embodiment of the present disclosure.

FIG. 13 is a diagram illustrating an application example of a damage rate curve application device according to a second embodiment of the present disclosure.

### DESCRIPTION OF EMBODIMENTS

Hereinafter, embodiments of the present disclosure will be described with reference to the drawings as appropriate. The embodiments described below are examples of a configuration of the present disclosure, and the present disclosure is not limited to the following embodiments.

### First Embodiment

<Schematic Configuration of System 1>

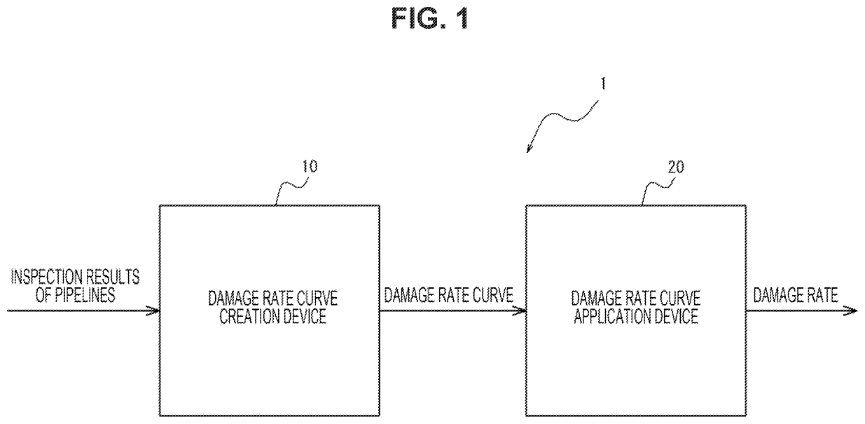

FIG. 1 is a diagram illustrating a configuration of a main part of a system 1 according to a first embodiment of the present disclosure. As illustrated in FIG. 1, the system 1 includes a damage rate curve creation device 10 and a damage rate curve application device 20.

The damage rate curve creation device 10 and the damage rate curve application device 20 may be communicably connected by wire or wirelessly. A communication method for transmitting and receiving information between the devices is not particularly limited. In addition, the damage rate curve creation device 10 and the damage rate curve application device 20 may be integrated.

The damage rate curve creation device 10 creates damage rate curves by using first pipeline damage data including information on presence or absence of damage in pipelines. The damage rate curve creation device 10 transmits the created damage rate curves to the damage rate curve application device 20. Specifically, as described in detail below, the damage rate curve creation device 10 uses the first pipeline damage data to create N (N 2) machine learning models that predict and output a first damage rate, and extracts feature amounts from a created first machine learning model to specify a feature amount having high contribution to the prediction. The damage rate curve creation device 10 analyzes a change in the first damage rate related to a change in the feature amount. A value of the feature amount at an inflection point of the change in the damage rate is then specified as an extreme value, and data having a value of the feature amount at which a difference from the extreme value is equal to or less than a threshold value is output as second pipeline damage data from the first pipeline damage data. The damage rate curve creation device 10 further calculates a second damage rate based on the second pipeline damage data, and performs fitting using a fitting function to create a damage rate curve indicating the second damage rate. The damage rate curve creation device 10 outputs N created damage rate curves to the damage rate curve application device 20.

The damage rate curve application device 20 applies data indicating earthquake motion index information and pipeline information to the N damage rate curves to estimate a damage rate of a pipeline from the damage rate curves. Specifically, as described in detail below, the damage rate curve application device 20 acquires the data indicating the earthquake motion index information and the pipeline information according to a type of earthquake motion index information and a pipeline characteristic input by a user. The acquired data is then applied to the damage rate curves received from the damage rate curve creation device 10, the damage rate of the pipeline is read, and the result is output for each pipeline characteristic.

<Configuration of Damage Rate Curve Creation Device 10>

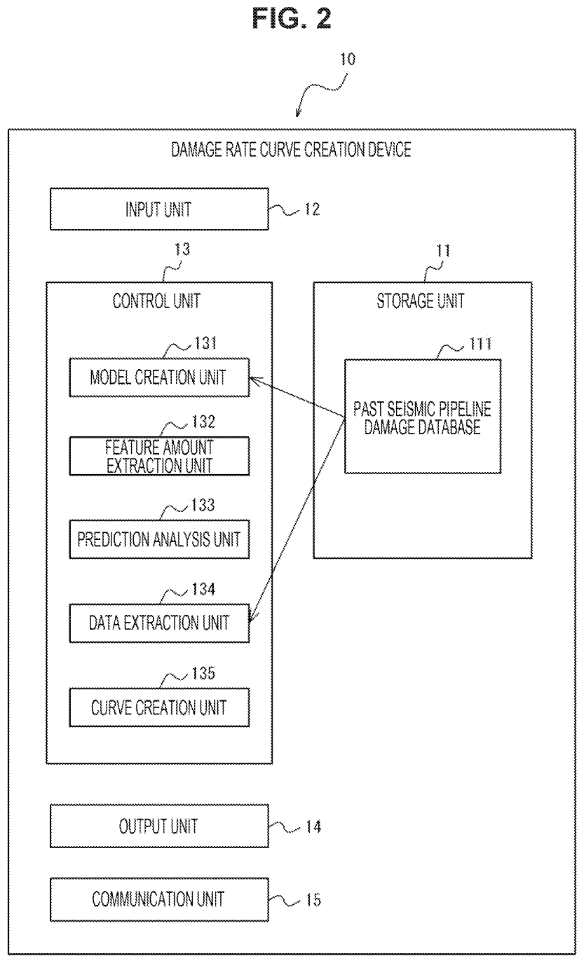

FIG. 2 is a diagram illustrating an example of a configuration of the damage rate curve creation device 10 according to the present embodiment. As illustrated in FIG. 2, the damage rate curve creation device 10 includes a storage unit 11, an input unit 12, a control unit 13, an output unit 14, and a communication unit 15.

The storage unit 11 includes one or more memories, and may include, for example, a semiconductor memory, a magnetic memory, an optical memory, or the like. Each memory included in the storage unit 11 may function as, for example, a main storage device, an auxiliary storage device, or a cache memory. The storage unit 11 stores various types of information used for operation of the damage rate curve creation device 10. The storage unit 11 stores a past seismic pipeline damage database 111 and various programs and various types of information necessary for the control unit 13 to execute various types of processing. The storage unit 11 preferably stores machine learning models created by a model creation unit 131 of the control unit 13 to be described later and damage rate curves created by a curve creation unit 135. At this time, if the storage unit 11 can be referred to from another terminal, the machine learning models and the damage rate curves can be viewed from a plurality of terminals. The storage unit 11 may be, for example, a hard disk or a nonvolatile memory of a file server accessible from the control unit 13 via a network. Even with such a configuration, the storage unit 11 functions as a part of the damage rate curve creation device 10, and the control unit 13 can access the storage unit 11 when necessary.

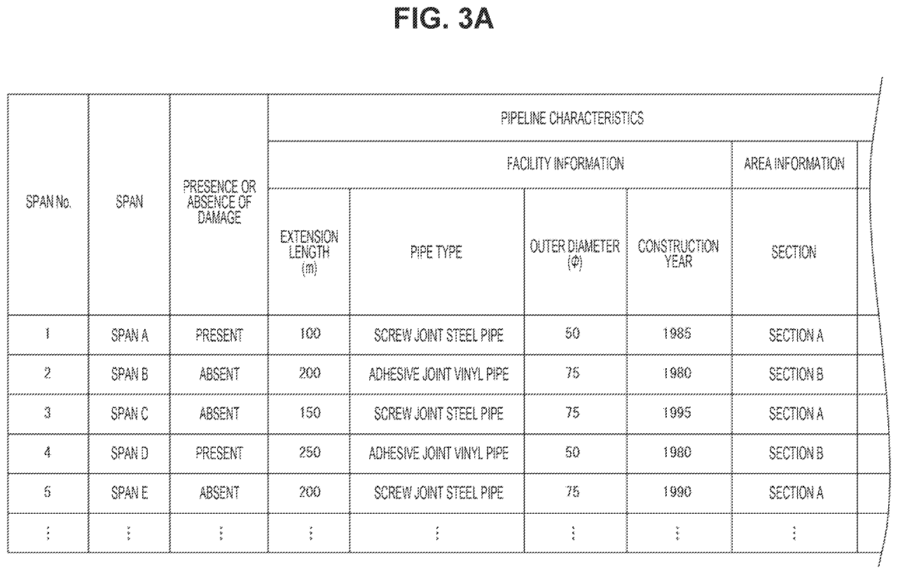

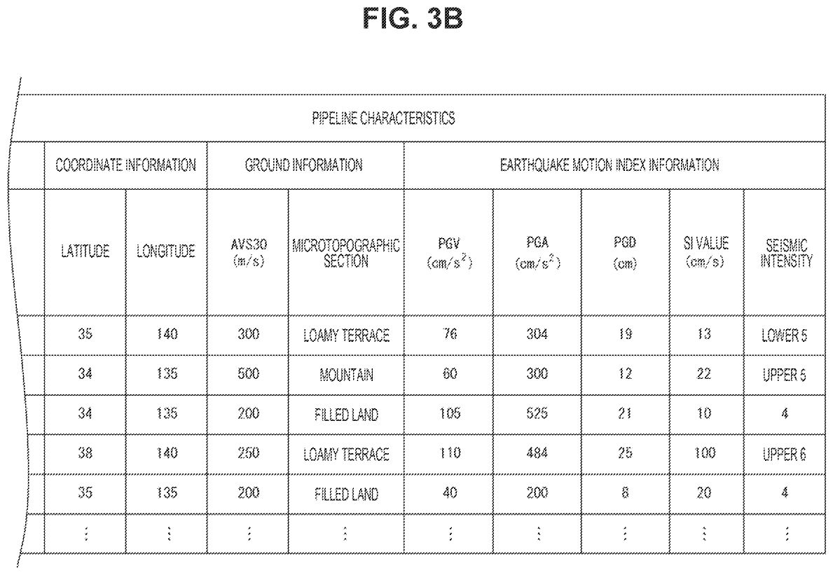

The past seismic pipeline damage database 111 stores information on inspection results for each span at the time of a past earthquake as a record including a span number, a span name, presence or absence of damage, and pipeline characteristics in association with each other. FIGS. 3A and 3B are diagrams illustrating an example of the past seismic pipeline damage database 111. In this example, one record corresponds to one row in FIGS. 3A and 3B. The “span” refers to a section of an underground pipeline disposed between manholes, and a section related to a bridge including a bridge attachment pipe and a connection pipe to a bridge base. The “pipeline characteristics” include, for example, presence or absence of damage due to the earthquake, an extension length of the span, a pipe type, an outer diameter, a construction year, a section to which the span belongs, a latitude and longitude of a central portion of the span, an average shear-wave velocity (AVS) 30 at a position where the span is disposed, a microtopographic section, and a peak ground velocity (PGV), a peak ground acceleration (PGA), a peak ground displacement (PGD), an SI value, a seismic intensity, and the like at a position where the span is disposed at the time of the past earthquake. The section to which the span belongs is a predetermined section such as a fixed wiring section. In the present embodiment, one section has a size of 250 m×250 m, but is not limited thereto, and may be freely set. The AVS 30 refers to an average S-wave velocity from the ground surface to a depth of 30 m. The PGA refers to the maximum acceleration of the earthquake motion. The PGV refers to the maximum velocity of the earthquake motion. The PGD refers to the maximum degree of displacement of the earthquake motion. In the present embodiment, the PGD value is approximated by a value obtained by squaring the PGV value and dividing the squared value by the PGA value. As illustrated in FIGS. 3A and 3B, the pipeline characteristics can be divided into categories of information on the presence or absence of damage, facility information, area information, coordinate information, ground information, and earthquake motion index information. Note that the example illustrated in FIGS. 3A and 3B is information in a table format, but the present invention is not limited thereto, and any format may be used as long as the information associates each piece of the above information. The past seismic pipeline damage database 111 is updated by a user inputting results of inspecting damage in each pipeline after occurrence of an earthquake. As a result, the accuracy of the machine learning models and the damage rate curves created by use of the information of the past seismic pipeline damage database 111 is improved.

The pipeline characteristics included in the facility information are not limited to the examples illustrated in FIGS. 3A and 3B, and may include a material of the pipeline, a bending angle, presence or absence of protective concrete, presence or absence of a nearby structure, a longitudinal slope of the place where the pipeline is disposed, and the like. The pipeline characteristics included in the ground information are not limited to the examples illustrated in FIGS. 3A and 3B, and may include an average inclination angle, an average elevation, information on whether the land is artificially flattened, a basic natural period of the ground, and the like. In addition, the microtopographic section is not limited to the examples illustrated in FIGS. 3A and 3B, and may include a mountain foot slope, a hill, a volcano, a volcanic foot slope, a volcanic hill, a rocky strath terrace, a gravelly terrace, a valley bottom lowland, an alluvial fan, a natural levee, a back marsh, an abandoned river channel, a delta and coastal lowland, a marine sand and gravel bar, a sand dune, a lowland between coastal dunes and/or bars, a reclaimed land, a rock shore and rock reef, a dry riverbed, a river bed, a lake, and the like. The pipeline characteristics included in the earthquake motion index information are not limited to the examples illustrated in FIGS. 3A and 3B, and may include an equivalent dominant period of the earthquake, a value of a ground strain based on a gas guideline, and the like.

The input unit 12 receives each piece of information on inspection results of the pipelines at the time of a past earthquake from the user. The input unit 12 may be, for example, at least one of a keyboard and a mouse, or may be a touch panel, but is not particularly limited. Each piece of information received by the input unit 12 is stored in the past seismic pipeline damage database 111 of the storage unit 11 and used for model creation processing to be described later.

The control unit 13 includes the model creation unit 131, a feature amount extraction unit 132, a prediction analysis unit 133, a data extraction unit 134, and the curve creation unit 135. The control unit 13 may be configured by dedicated hardware, or may be configured by a general-purpose processor or a processor specialized for specific processing.

The model creation unit 131 refers to the storage unit 11, acquires records included in the past seismic pipeline damage database 111, puts the records together for each of N pipeline characteristics, and stores the records in the storage unit 11 as first pipeline damage data for generating N machine learning models. The model creation unit 131 performs machine learning for each of the N sets of first pipeline damage data, and generates the N machine learning models that predict and output a first damage rate of a pipeline for each pipeline characteristic. The machine learning method may be based on binary classification regression using random forests or gradient boosting, but is not limited thereto. The methods of the random forests and the gradient boosting are well-known methods, and thus details thereof are omitted here. Here, the “first damage rate” refers to a probability of presence or absence of earthquake damage in a span having a certain pipeline characteristic, and is represented by a continuous value from 0 to 1. The closer the first damage rate is to 0, the lower the possibility of earthquake damage in the span having the certain pipeline characteristic, and the closer the first damage rate is to 1, the higher the possibility of earthquake damage in the span having the certain pipeline characteristic.

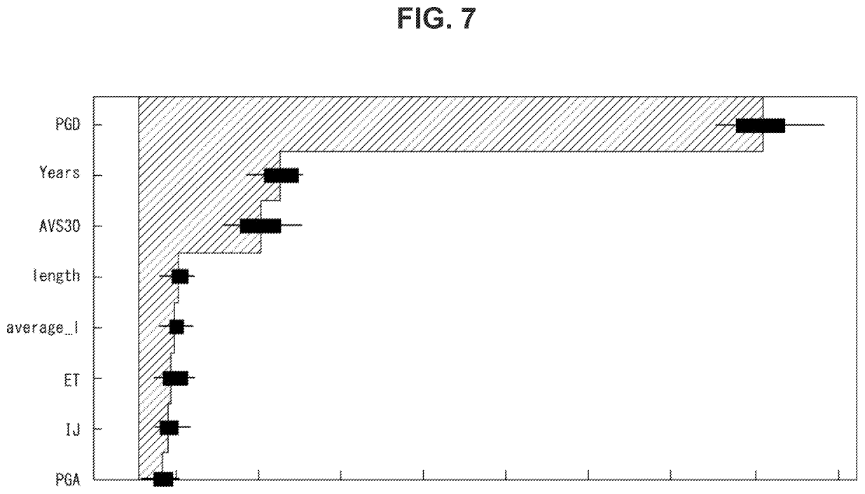

The feature amount extraction unit 132 refers to the storage unit 11, acquires the machine learning models created by the model creation unit 131, extracts feature amounts for each of the acquired machine learning models, and extracts a feature amount having the highest contribution to the prediction of the machine learning model. In the present embodiment, the feature amounts refer to the earthquake motion indexes, but are not limited thereto, and may be other pipeline characteristics. The feature amounts may be extracted by use of a permutation feature importance method. The permutation feature importance method is a well-known method, and thus details thereof are omitted here. FIG. 7 is a diagram illustrating pipeline characteristics having high contribution to prediction of a machine learning model having a “screw joint steel pipe” as a pipeline characteristic, which are extracted by the feature amount extraction unit 132, in descending order of contribution. The vertical axis represents the pipeline characteristics that contribute to the prediction of the machine learning model, and the horizontal axis represents the amount of decrease in the area under the ROC curve of the created first machine learning model, which is an area under the curve (AUC). As can be seen from FIG. 7, when the feature amounts are extracted for the machine learning model having the “screw joint steel pipe” as a pipeline characteristic, the feature amount having the highest contribution is the PGD. Therefore, the feature amount extraction unit 132 extracts the PGD as the feature amount.

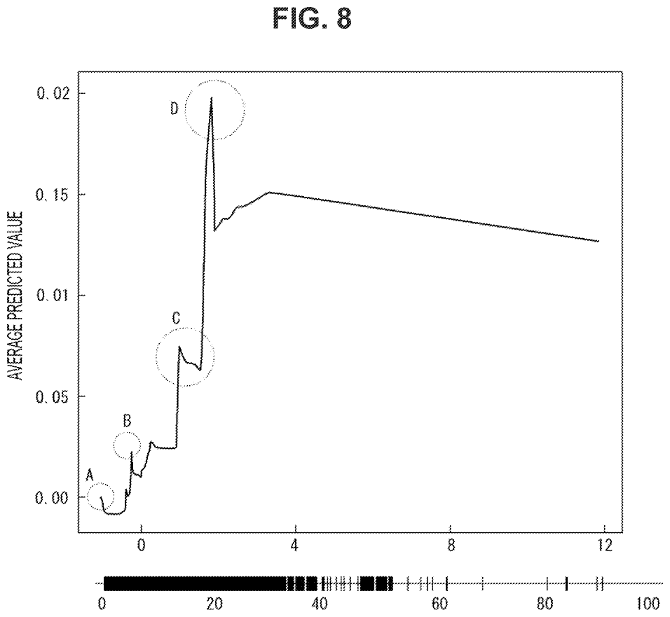

The prediction analysis unit 133 analyzes a change in the first damage rate output by the created machine learning model related to a change in the value of the earthquake motion index extracted by the feature amount extraction unit 132. For the analysis of the change in the first damage rate, an accumulated local effect plot method may be used. Since the accumulated local effect plot method is well known, the description thereof is omitted here. The prediction analysis unit 133 uses the value of the earthquake motion index as a variable, and analyzes how the damage rate changes as the value changes. The prediction analysis unit 133 represents the analysis result on a plane. FIG. 8 illustrates an example of the analysis result in a case where the feature amount is the PGD. In FIG. 8, the change in the first damage rate related to the change in the PGD value is represented by a continuous graph with the vertical axis representing the average predicted value of the first damage rate and the horizontal axis representing the PGD value.

The data extraction unit 134 specifies the value of the feature amount at an inflection point of the change in the first damage rate analyzed by the prediction analysis unit 133 as an extreme value. Referring to FIG. 8, portions denoted by signs A to D, which are surrounded by four circles, indicate inflection points at which the first damage rate greatly changes. The data extraction unit 134 specifies a PGD value at each of the inflection points as an extreme value. In FIG. 8, the PGD values at the inflection points A to D are 1 cm, 7 cm, 14 cm, and 19.5 cm, respectively. In the present embodiment, each of the extreme values is specified as an integer value by a fractional value being rounded off. Therefore, the PGD value of 19.5 cm, which is the extreme value at the inflection point denoted by the sign D, is specified as a PGD value of 20 cm. The specified extreme values may be values including fractional values.

The data extraction unit 134 extracts, from the first pipeline damage data, data having a value of the feature amount at which a difference from an extreme value is equal to or less than a threshold value as second pipeline damage data. In the present embodiment, the data extraction unit 134 extracts, from the first pipeline damage data, a record having a value of the feature amount at which a difference from one of the PGD value of 1 cm, 7 cm, 14 cm, and 20 cm as the extreme values at the inflection points A to D is equal to or less than the threshold value, as the second pipeline damage data. The threshold value in the present embodiment is a value within a range of ±1 cm of a PGD value as an extreme value. The threshold value is not limited thereto, and may be freely set. The second pipeline damage data is extracted from each of the N sets of first pipeline damage data. The data extraction unit 134 stores the N extracted sets of second pipeline damage data in the storage unit 11.

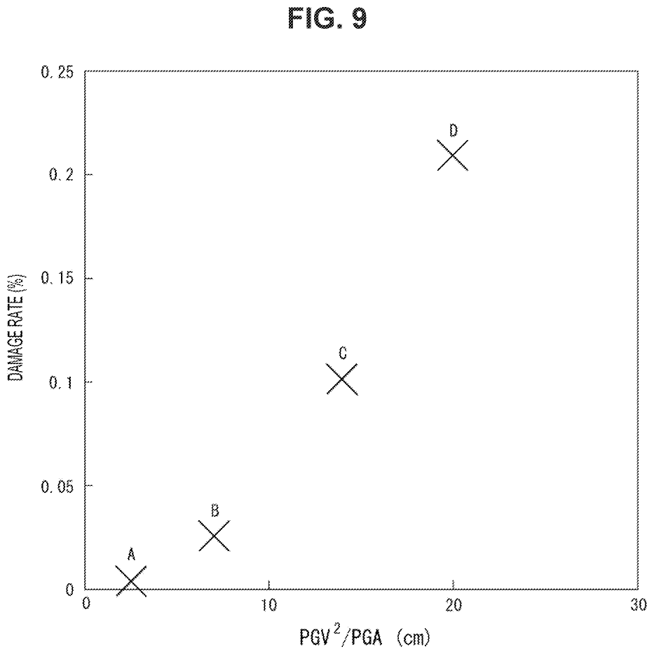

The curve creation unit 135 refers to the storage unit 11, calculates a second damage rate based on the second pipeline damage data extracted by the data extraction unit 134, and creates a damage rate curve. The “second damage rate” in the present embodiment is represented by a value obtained by dividing the number of records having earthquake damage in the second pipeline damage data by the total number of records of the first pipeline damage data having the concerned pipeline characteristic. The curve creation unit 135 performs plotting on a plane having the calculated second damage rate on the Y axis and the extreme values specified by the data extraction unit 134 on the X axis. FIG. 9 illustrates an example of the plotting by the curve creation unit 135. In FIG. 9, it is indicated that, when the PGD value of the extreme value at the inflection point denoted by the sign D is 20 cm, the second damage rate is 0.209, that is, 20.9 percent. Next, the curve creation unit 135 creates a curve based on the plotting by use of a fitting function to obtain a damage rate curve. In the present embodiment, the fitting function is a sigmoid function, but is not limited thereto. The curve creation unit 135 stores the damage rate curve created for each pipeline characteristic in the storage unit 11.

The output unit 14 outputs the N damage rate curves created by the curve creation unit 135 to the damage rate curve application device 20. As a result, the damage rate curve application device 20 can estimate the damage rate of the pipeline by applying the damage rate curves created by the damage rate curve creation device 10 to data indicating earthquake motion index information and pipeline information. The output unit 14 may be a liquid crystal display, an organic EL display, an inorganic EL display, or the like, and may be configured to be able to display the created damage rate curves to the user.

The communication unit 15 includes at least one communication interface. The communication interface is, for example, a LAN interface. The communication unit 15 receives information used for the operation of the damage rate curve creation device 10 and transmits information obtained by the operation of the damage rate curve creation device 10.

<Configuration of Damage Rate Curve Application Device 20>

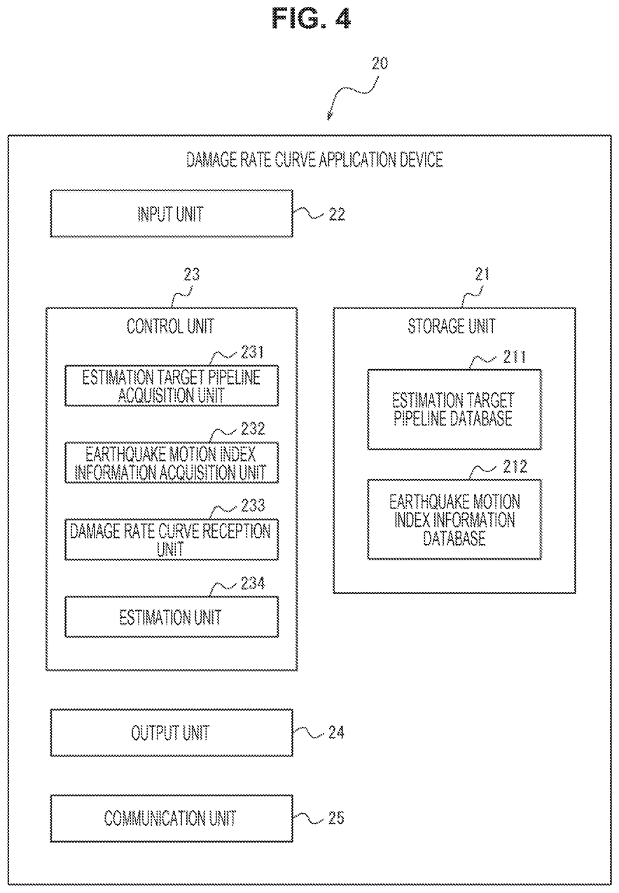

FIG. 4 is a diagram illustrating an example of a configuration of the damage rate curve application device 20 according to the present embodiment. As illustrated in FIG. 4, the damage rate curve application device 20 includes a storage unit 21, an input unit 22, a control unit 23, an output unit 24, and a communication unit 25.

The storage unit 21 includes one or more memories, and may include, for example, a semiconductor memory, a magnetic memory, an optical memory, or the like. Each memory included in the storage unit 21 may function as, for example, a main storage device, an auxiliary storage device, or a cache memory. The storage unit 21 stores various types of information used for operation of the damage rate curve application device 20. The storage unit 21 stores an estimation target pipeline database 211, an earthquake motion index information database 212, the damage rate curves received from the damage rate curve creation device 10, and various programs and various types of information necessary for the control unit 23 to execute various types of processing. Here, the storage unit 21 preferably stores various calculation results of the damage rate curve application device 20 according to the present embodiment. At this time, if the storage unit 21 can be referred to from another terminal, an estimation result of the damage rate of the pipeline can be viewed from a plurality of terminals. The storage unit 21 may be, for example, a hard disk or a nonvolatile memory of a file server accessible from the control unit 23 via a network. Even with such a configuration, the storage unit 21 functions as a part of the damage rate curve application device 20, and the control unit 23 can access the storage unit 21 when necessary.

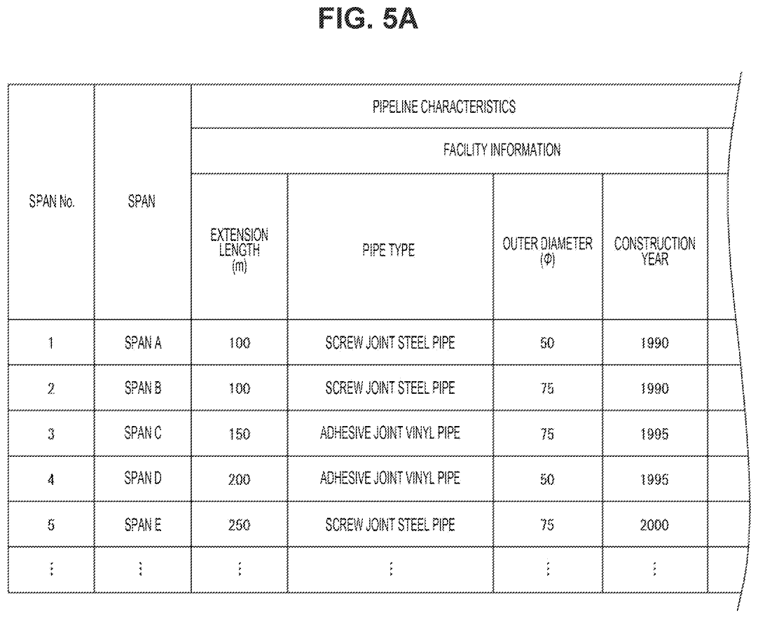

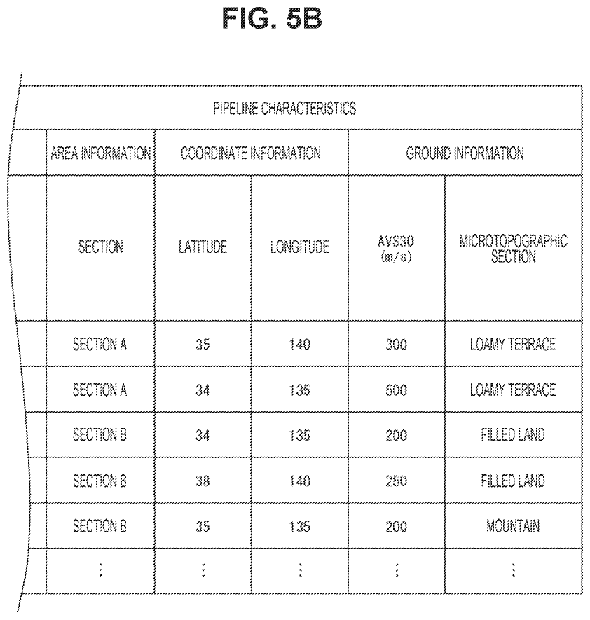

The estimation target pipeline database 211 stores information on a span for which a damage rate is estimated as a record including a span number, a span name, and pipeline characteristics in association with each other. The pipeline characteristics include coordinate information. FIGS. 5A and 5B illustrate an example of the estimation target pipeline database 211. The pipeline characteristics including facility information, area information, coordinate information, and ground information stored in the estimation target pipeline database 211 may be similar to the pipeline characteristics stored in the above-described past seismic pipeline damage database 111. The estimation target pipeline database 211 is not limited to the table format as illustrated in FIGS. 5A and 5B, and may have any format as long as the format associates each piece of the above information.

The earthquake motion index information database 212 stores earthquake motion index information and coordinate information acquired by the control unit 23 from an external device such as a server included in the J-SHIS. The earthquake motion index information database 212 stores a record including a predicted value and a promptly reported value of an earthquake motion index such as a PGV, PGA, PGD, SI, or seismic intensity and corresponding coordinate information in association with each other. The predicted value is a value of an earthquake motion index before occurrence of an earthquake, which is assumed when the earthquake occurs in the future. The promptly reported value is a value of an earthquake motion index measured immediately after the occurrence of the earthquake. For example, the earthquake motion index information database 212 stores a record indicating a PGD value of 20 cm as a predicted value of an earthquake assumed to directly hit the metropolitan area in the future and a latitude of 35 degrees to 36 degrees and a longitude of 139 degrees to 140 degrees as corresponding coordinate information. This record indicates that the PGD value is predicted to be 20 cm in an area within the latitude of 35 degrees to 36 degrees and the longitude of 139 degrees to 140 degrees in a case where the earthquake that directly hits the metropolitan area occurs in the future. The earthquake motion index information database 212 is updated by the control unit 23 constantly or periodically acquiring data from an external device.

The input unit 22 receives an input of an estimation target pipeline characteristic and a type of earthquake motion index information from a user. In the present embodiment, the “type of earthquake motion index information” refers to one of a predicted value or a promptly reported value of each earthquake motion index, but is not limited thereto. The type of earthquake motion index information may be freely set, and for example, a value after a lapse of a predetermined period from the occurrence of the earthquake may be used. Via the input unit 22, the user inputs the predicted value in a case where the user desires to estimate the damage rate of the pipeline before the occurrence of the earthquake, and inputs the promptly reported value in a case where the user desires to estimate the damage rate of the pipeline after the occurrence of the earthquake. For example, the user inputs the “screw joint steel pipe” as a pipeline characteristic and inputs the “predicted value” as a type of earthquake motion index information via the input unit 22. The input unit 22 may be, for example, at least one of a keyboard and a mouse, or may be a touch panel integrated with the output unit 24, but is not particularly limited. The information input by the input unit 22 is transmitted to the control unit 23 and used for damage rate estimation processing of the control unit 23.

The control unit 23 includes an estimation target pipeline acquisition unit 231, an earthquake motion index information acquisition unit 232, a damage rate curve reception unit 233, and an estimation unit 234. The control unit 23 may be configured by dedicated hardware, or may be configured by a general-purpose processor or a processor specialized for specific processing.

The estimation target pipeline acquisition unit 231 acquires a record of a span having the pipeline characteristic input via the input unit 22 from the estimation target pipeline database 211 of the storage unit 21. For example, in a case where the pipeline characteristic input via the input unit 22 is the “screw joint steel pipe”, the estimation target pipeline acquisition unit 231 selects and acquires records of spans Nos. 1, 2, and 5, which each have the “screw joint steel pipe” as a pipeline characteristic among the records in FIGS. 5A and 5B. The estimation target pipeline acquisition unit 231 stores the acquired record in the storage unit 21.

The earthquake motion index information acquisition unit 232 acquires a record including earthquake motion index information and coordinate information corresponding to the type of earthquake motion index information input via the input unit 22 from the earthquake motion index information database 212 of the storage unit 21. For example, in a case where the type of earthquake motion index information input via the input unit 22 is the “predicted value”, the earthquake motion index information acquisition unit 232 selects and acquires a record indicating a PGD value of 20 cm as a predicted value and a latitude of 35 degrees to 36 degrees and a longitude of 139 degrees to 140 degrees as corresponding coordinate information. The earthquake motion index information acquisition unit 232 stores the acquired record in the storage unit 21.

The damage rate curve reception unit 233 receives a damage rate curve corresponding to the pipeline characteristic from the damage rate curve creation device 10. The damage rate curve reception unit 233 stores the received damage rate curve in the storage unit 21. The damage rate curve reception unit 233 may periodically receive a damage rate curve from the damage rate curve creation device 10 and store the damage rate curve in the storage unit 21, for example. The damage rate curve reception unit 233 may receive a damage rate curve from the damage rate curve creation device 10 when there is an input from the user via the input unit 22. For example, in a case where the pipeline characteristic input by the user is the “screw joint steel pipe”, the damage rate curve reception unit 233 receives, from the damage rate curve creation device 10, the damage rate curve created based on the records each having the “screw joint steel pipe” as a pipeline characteristic in the damage rate curve creation device 10.

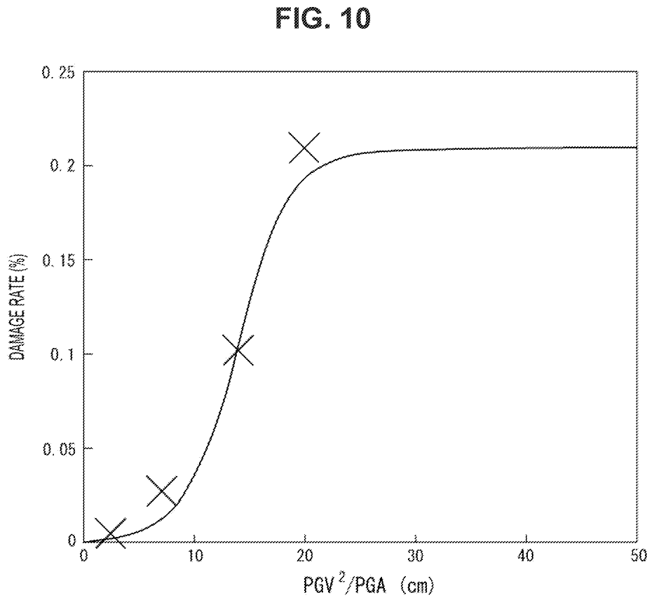

The estimation unit 234 estimates the damage rate based on the information acquired by the estimation target pipeline acquisition unit 231 and the earthquake motion index information acquisition unit 232 and the damage rate curve received by the damage rate curve reception unit 233. Specifically, the estimation unit 234 first refers to the storage unit 21, and associates the coordinate information of the record acquired by the estimation target pipeline acquisition unit 231 with the coordinate information of the record acquired by the earthquake motion index information acquisition unit 232. Next, the predicted value or promptly reported value of the earthquake motion index acquired by the earthquake motion index information acquisition unit 232 is added to the record acquired by the estimation target pipeline acquisition unit 231 based on the associated coordinate information. The damage rate corresponding to the added predicted value or promptly reported value of the earthquake motion index is then read from the curve acquired by the damage rate curve reception unit 233. For example, it is assumed that the earthquake motion index information acquisition unit 232 stores the record indicating the PGD value of 20 cm as a predicted value and the values of latitude of 35 degrees to 36 degrees and longitude of 139 degrees to 140 degrees as corresponding coordinate information in the storage unit 21. Furthermore, it is assumed that the estimation target pipeline acquisition unit 231 stores the records of the span Nos. 1, 2, and 5 in FIGS. 5A and 5B in the storage unit 21. The estimation unit 234 adds the PGD value of 20 cm, which is the predicted value of the earthquake motion index, to the record of the span No. 1, which has values of coordinates included in the range of the coordinate information of the record acquired by the earthquake motion index information acquisition unit 232, and stores the obtained record in the storage unit 21. The estimation unit 234 reads that the damage rate corresponding to the PGD value of 20 cm is 20.9 percent from the damage rate curve of FIG. 10 acquired by the damage rate curve reception unit 233. In this manner, the estimation unit 234 estimates the damage rate of each span. The estimation unit 234 may be configured to use any value set by the user as a value of the earthquake motion index in a case where the earthquake motion index corresponding to the record acquired by the estimation target pipeline acquisition unit 231 is not acquired by the earthquake motion index information acquisition unit 232. The estimation unit 234 stores the estimation result of the damage rate in the storage unit 21.

The output unit 24 displays the estimation result of the damage rate to the user. The output unit 24 is, for example, a liquid crystal display, an organic EL display, an inorganic EL display, or the like. Furthermore, the output unit 24 may be a touch panel, and in this case, the output unit 24 displays the estimation result to the user and functions as the input unit 22 that receives an input by operation of the user.

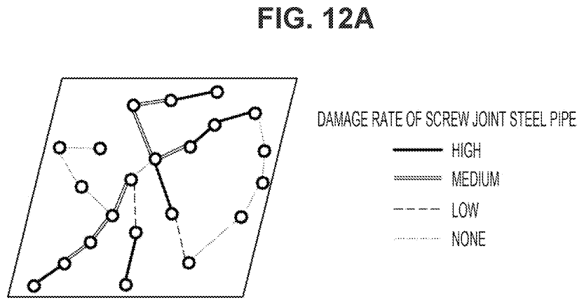

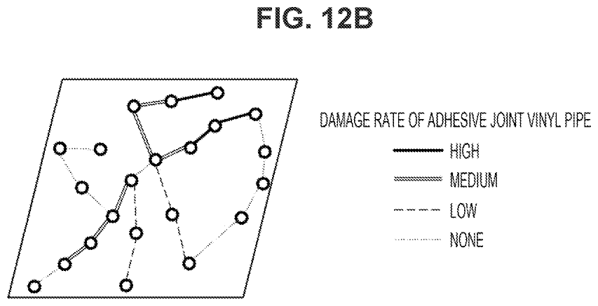

The output unit 24 may represent the estimation result as a numerical value, or may divide numerical values into predetermined ranges and display the estimation result by high, medium, and low levels. The estimation result may be displayed together with map information. An example of displaying the estimation result together with the map information is illustrated in FIGS. 12A and 12B. FIGS. 12A and 12B are display examples in a case where the user inputs the predicted value as a type of earthquake motion index information. FIG. 12A is an example of estimation results of damage rates of spans each having the “screw joint steel pipe” as a pipeline characteristic, which are displayed on the output unit 24. FIG. 12B is an example of estimation results of damage rates of spans each having an “adhesive joint vinyl pipe” as a pipeline characteristic, which are displayed on the output unit 24. Note that a white circle represents a manhole, and a solid line, a double line, a large interval broken line, and a small interval broken line represent a span connecting manholes. The output unit 24 displays the damage rate of each span by a solid line (high damage rate), a double line (medium damage rate), a large interval broken line (low damage rate), or a small interval broken line (no vulnerability) according to the height of the damage rate. When viewing a screen displayed on the output unit 24, the user can unitarily grasp the estimation results of the damage rates in a case where an earthquake occurs in the future on the map for each input pipeline characteristic.

In the display of the output unit 24, the output estimation results of the damage rates are switched and displayed based on the type of earthquake motion index information input by the user and the input pipeline characteristic. The output unit 24 may be configured to be able to display the map separately for each section having, for example, a size of 1 km×1 km or a size of 250 m×250 m by operation of the user. The output unit 24 may be able to display the spans and the estimation results of the damage rates in a list in addition to displaying the spans and the estimation results in a planar manner on the map.

The communication unit 25 includes at least one communication interface. The communication interface is, for example, a LAN interface. The communication unit 25 receives information used for the operation of the damage rate curve application device 20 and transmits information obtained by the operation of the damage rate curve application device 20.

<Program>

Each of the damage rate curve creation device 10 and the damage rate curve application device 20 may be a computer capable of executing program commands. The computer stores a program in which processing contents for implementing each function of the damage rate curve creation device 10 and the damage rate curve application device 20 are described in a storage unit of the computer, and reads and executes the program by a processor of the computer. A part of these processing contents may be implemented by hardware. Here, the computer may be a general-purpose computer, a dedicated computer, a workstation, a personal computer (PC), an electronic notebook pad, or the like. The program commands may be program codes, code segments, or the like for performing required tasks. The processor may be a central processing unit (CPU), a graphics processing unit (GPU), a digital signal processor (DSP), or the like.

Furthermore, the program may be recorded in a computer-readable recording medium. Using such a recording medium makes it possible to install the program in the computer. Here, the recording medium in which the program is recorded may be a non-transitory recording medium. The non-transitory recording medium is not particularly limited, but may be, for example, a recording medium such as a CD-ROM or a DVD-ROM. Furthermore, the program can also be provided by being downloaded via a network.

Next, operation of the system 1 according to the present embodiment will be described.

<Operation of Damage Rate Curve Creation Device 10>

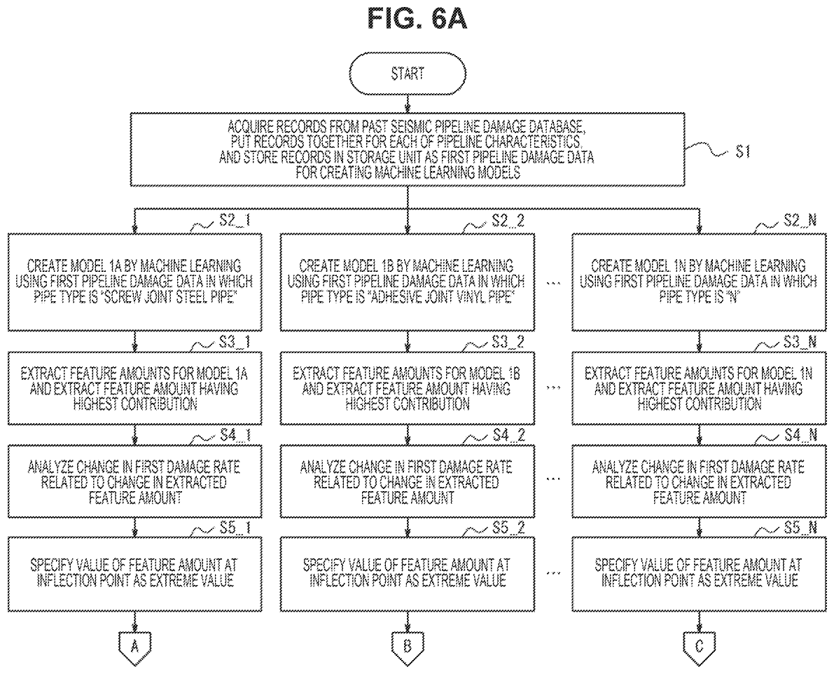

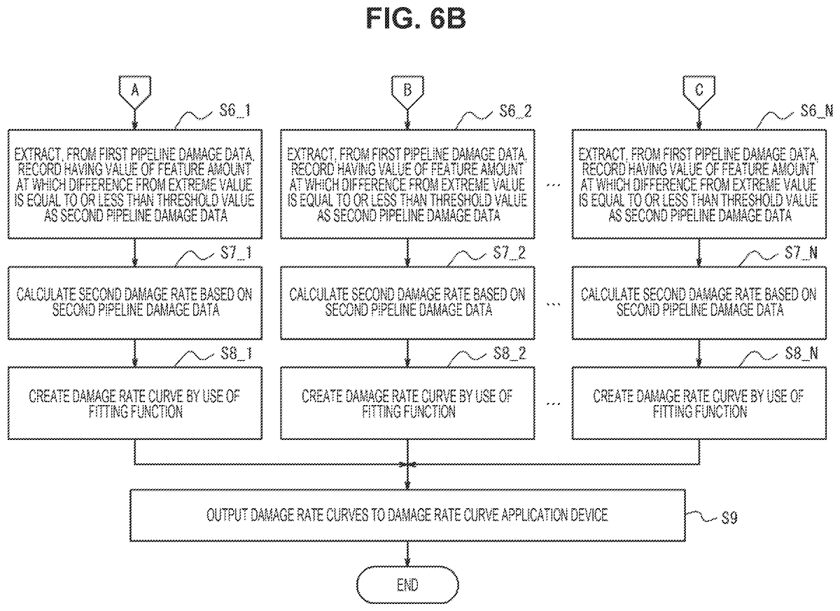

First, the operation of the damage rate curve creation device 10 included in the system 1 will be described. This operation corresponds to a damage rate curve creation method according to the present embodiment. FIGS. 6A and 6B are a flowchart illustrating an example of the operation of the damage rate curve creation device 10 included in the system 1.

The model creation unit 131 of the damage rate curve creation device 10 acquires records included in the past seismic pipeline damage database 111, puts the records together for each of N pipeline characteristics, and stores the records in the storage unit 11 as first pipeline damage data for creating N machine learning models (step S1). Among the records stored in the past seismic pipeline damage database 111 illustrated in FIGS. 3A and 3B, the model creation unit 131 sets records each having a “screw joint steel pipe” as a pipeline characteristic, that is, records of span Nos. 1, 3, and 5 as a set of data, and sets records each having an “adhesive joint vinyl pipe” as a pipeline characteristic, that is, records of span Nos. 2 and 4 as a set of data, thereby dividing the records by the pipeline characteristics. In this manner, the model creation unit 131 divides the records included in the past seismic pipeline damage database 111 by the pipeline characteristics into N sets. The model creation unit 131 stores each of the sets of data in the storage unit 11 as first pipeline damage data.

The model creation unit 131 performs machine learning for each pipeline characteristic by using the N sets of first pipeline damage data obtained by the division in step S1 as learning data, and generates machine learning models that output a first damage rate for each pipeline characteristic (steps S2_1 to S2_N). Referring to FIGS. 3A and 3B, the model creation unit 131 performs machine learning using, as learning data, the records each having the “screw joint steel pipe” as a pipeline characteristic, that is, the records of the span Nos. 1, 3, and 5 (step S2_1). In addition, the model creation unit 131 performs machine learning using, as learning data, records each having the “adhesive joint vinyl pipe” as a pipeline characteristic, that is, the records of the span Nos. 2 and 4 (step S2_2). In this manner, the model creation unit 131 performs machine learning for each of the N sets of data to perform a total of N sets of machine learning (S2_1 to step S2_N). The model creation unit 131 then stores each of the machine learning models 1A to 1N created in steps S2_1 to S2_N in the storage unit 11.

Next, the feature amount extraction unit 132 refers to the storage unit 11, acquires the N machine learning models 1A to 1N created by the model creation unit 131, extracts feature amounts for each model, and extracts a feature amount having the highest contribution to prediction of the machine learning model (steps S3_1 to S3_N). FIG. 7 is a diagram illustrating results of extraction by the feature amount extraction unit 132, in which the feature amounts are extracted for the machine learning model 1A having the “screw joint steel pipe” as a pipeline characteristic, in descending order of contribution. As can be seen from FIG. 7, when the feature amounts are extracted for the machine learning model 1A having the “screw joint steel pipe” as a pipeline characteristic, the feature amount having the highest contribution is the PGD as an earthquake motion index. Therefore, the feature amount extraction unit 132 extracts the PGD as the feature amount.

Next, the prediction analysis unit 133 analyzes a change in the first damage rate related to a change in the extracted feature amount (steps S4_1 to S4_N). In the present embodiment, the prediction analysis unit 133 analyzes how the first damage rate changes as the PGD value of the first pipeline damage data changes, by using the accumulated local effect plot method. FIG. 8 illustrates a result analyzed by the prediction analysis unit 133. In FIG. 8, the change in the first damage rate related to the change in the PGD value is represented by a continuous graph with the vertical axis representing the average predicted value of the first damage rate and the horizontal axis representing the PGD value.

Next, the data extraction unit 134 specifies the value of the feature amount at an inflection point of the change in the first damage rate analyzed by the prediction analysis unit 133 as an extreme value (steps S5_1 to S5_N). Referring to FIG. 8, portions denoted by signs A to D, which are surrounded by four circles, indicate inflection points at which the first damage rate greatly changes. The data extraction unit 134 specifies a PGD value as an extreme value at each of the four inflection points. In the present embodiment, the data extraction unit 134 reads a PGD value of 19.5 cm as the extreme value at the inflection point denoted by the sign D, and specifies a PGD value of 20 cm by rounding off the decimal to the nearest integer.

Next, the data extraction unit 134 extracts, from the first pipeline damage data, data having a value of the feature amount at which a difference from an extreme value is equal to or less than a threshold value as second pipeline damage data (steps S6_1 to S6_N). In the present embodiment, the data extraction unit 134 extracts, from the first pipeline damage data, a record having a value of the feature amount at which a difference from a PGD value as a specified extreme value is equal to or less than the threshold value. Referring to FIG. 3B, the records of the span Nos. 1, 3, and 5 included in the first pipeline damage data having the “screw joint steel pipe” as a pipeline characteristic have PGD values of 19 cm, 21 cm, and 8 cm, respectively. The data extraction unit 134 extracts the records of the spans Nos. 1 and 3, in which a difference from the PGD value of 20 cm specified as the extreme value at the inflection point denoted by the sign D is equal to or less than the threshold value, as the second pipeline damage data. In the present embodiment, the threshold value is a value within a range of ±1 cm of the PGD value. In addition to these records, the data extraction unit 134 extracts, from the first pipeline damage data, a record having a PGD value at which a difference from the PGD value of 20 cm is equal to or less than the threshold value. The data extraction unit 134 stores the extracted records in the storage unit 11.

Next, the curve creation unit 135 calculates a second damage rate based on the second pipeline damage data (steps S7_1 to S7_N). The curve creation unit 135 calculates the second damage rate by dividing the number of records having earthquake damage in the second pipeline damage data by the total number of records of the first pipeline damage data having the concerned pipeline characteristic. Referring to FIGS. 3A and 3B, among the records of the spans No. 1 and 3 extracted as the second pipeline damage data in step S6_1, the span No. 1 is a record having earthquake damage. Therefore, the curve creation unit 135 divides the number of records having earthquake damage, which include the span No. 1, by the total number of records of the first pipeline damage data having the “screw joint steel pipe” as a pipeline characteristic. In the present embodiment, the number of records having earthquake damage in the second pipeline damage data is 209, and the total number of records of the first pipeline damage data having the “screw joint steel pipe” as a pipeline characteristic is 1000. Therefore, the curve creation unit 135 calculates the second damage rate as 20.9 percent.

Next, the curve creation unit 135 creates damage rate curves (steps S8_1 to S8_N). Specifically, the curve creation unit 135 first performs plotting on a plane having the second damage rate on the Y axis and the extreme values specified by the data extraction unit 134 on the X axis. Referring to FIG. 9, it is indicated that, when the PGD value of the extreme value denoted by the sign D is 20 cm, the second damage rate is 0.209, that is, 20.9 percent. Next, the curve creation unit 135 creates a curve based on the plotting by use of a fitting function to obtain a damage rate curve. In the present embodiment, a sigmoid function is used as the fitting function. FIG. 10 illustrates the damage rate curve created based on the plotting illustrated in FIG. 9. The curve creation unit 135 creates the damage rate curve indicating the second damage rate for each of the N pipeline characteristics, and stores the damage rate curves in the storage unit 11.

The control unit 13 outputs each of the N damage rate curves stored in the storage unit 11 to the damage rate curve application device 20 via the output unit 14 (step S9). Thereafter, the control unit 13 ends the processing.

The damage rate curves are created by the above steps S1 to S9, and the created damage rate curves are output to the damage rate curve application device 20.

<Operation of Damage Rate Curve Application Device 20>

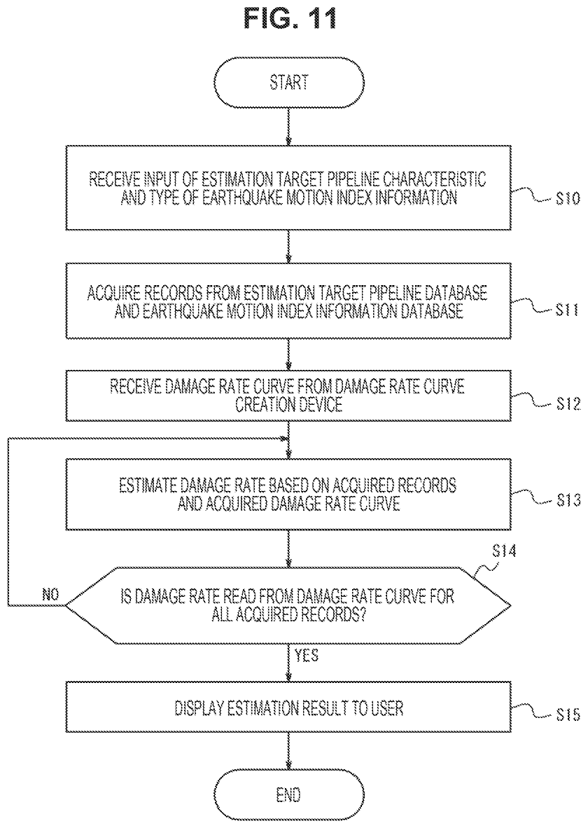

Next, the operation of the damage rate curve application device 20 included in the system 1 will be described. FIG. 11 is a flowchart illustrating an example of the operation of the damage rate curve application device 20 included in the system 1.

The input unit 22 of the damage rate curve application device 20 receives an input of an estimation target pipeline characteristic and a type of earthquake motion index information from a user (step S10). In the present embodiment, it is assumed that the user inputs a “screw joint steel pipe” as a pipeline characteristic and a “predicted value” as a type of earthquake motion index information.

The estimation target pipeline acquisition unit 231 acquires a record having the pipeline characteristic input via the input unit 22 from the estimation target pipeline database 211 of the storage unit 21. In addition, the earthquake motion index information acquisition unit 232 acquires a record including the earthquake motion index information and coordinate information from the earthquake motion index information database 212 of the storage unit 21 based on the type of earthquake motion index information input by the user. (step S11). In the present embodiment, the estimation target pipeline acquisition unit 231 selects and acquires records of span Nos. 1, 2, and 5 each having the “screw joint steel pipe” as a pipeline characteristic among the records stored in the estimation target pipeline database 211 illustrated in FIGS. 5A and 5B. The earthquake motion index information acquisition unit 232 acquires information indicating a PGD value of 20 cm as a “promptly reported value” of the earthquake motion index information, and a latitude of 35 degrees to 36 degrees and a longitude of 139 degrees to 140 degrees as corresponding coordinate information.

The damage rate curve reception unit 233 of the damage rate curve application device 20 receives a damage rate curve corresponding to the input pipeline characteristic from the damage rate curve creation device 10 (step S12). The damage rate curve reception unit 233 stores the received damage rate curve in the storage unit 21. In the present embodiment, the damage rate curve reception unit 233 receives, from the damage rate curve creation device 10, the damage rate curve created based on the records each having the “screw joint steel pipe” as a pipeline characteristic.

Next, the estimation unit 234 of the damage rate curve application device 20 refers to the storage unit 21, and estimates the damage rate based on the records acquired by the estimation target pipeline acquisition unit 231 and the earthquake motion index information acquisition unit 232 and the damage rate curve received by the damage rate curve reception unit 233 (step S13). First, the estimation unit 234 adds the PGD value of 20 cm as a promptly reported value of the earthquake motion index information to the record of the span No. 1 having coordinate values included in the range of the coordinate information acquired by the earthquake motion index information acquisition unit 232 among the records of the spans No. 1, 2, and 5 acquired by the estimation target pipeline acquisition unit 231, and stores the obtained record in the storage unit 21. The estimation unit 234 then reads that the damage rate corresponding to the PGD value of 20 cm added to the record of the span No. 1 is 20.9 percent from the damage curve of FIG. 10 acquired by the damage rate curve reception unit 233. The estimation unit 234 repeats step S13 until the damage rate is completely read from the damage rate curve for all the records acquired by the estimation target pipeline acquisition unit 231 (step S14). After reading the damage rate from the damage rate curve for all the acquired records, the estimation unit 234 stores the read damage rate of each span in the storage unit 21 as an estimation result.

The output unit 24 displays the estimation result of the damage rate of each span stored in the storage unit 21 to the user (step S15). The output unit 24 displays the damage rate of each span together with map information. FIG. 12A is an example in which the output unit 24 displays the damage rate. Referring to FIG. 12A, the damage rate of each span is displayed by a solid line (high damage rate), a double line (medium damage rate), a large interval broken line (low damage rate), or a small interval broken line (no damage rate). The output unit 24 can indicate the damage rate of each span on the map by switching the screen each time the user changes the input of the pipeline characteristic or the type of earthquake motion index.

By the above steps S10 to S15, the damage rate of each span is estimated.

As described above, a damage rate curve creation method according to the present embodiment includes: a step of creating a plurality of machine learning models that predict and output a first damage rate of a pipeline for each pipeline characteristic by use of first pipeline damage data including information on presence or absence of earthquake damage and pipeline characteristics; a step of extracting a feature amount having high contribution to the prediction for each of the machine learning models; a step of analyzing a change in the first damage rate related to a change in the feature amount; a step of specifying a value of the feature amount at an inflection point of the change in the first damage rate as an extreme value, and extracting, from the first pipeline damage data, data having a value of the feature amount at which a difference from the extreme value is equal to or less than a threshold value as second pipeline damage data; and a step of creating a damage rate curve indicating a second damage rate based on the second pipeline damage data.

According to the present embodiment, a damage rate curve corresponding to an estimation target pipeline characteristic to be estimated is created. Using the damage rate curve makes it possible to accurately estimate the damage rate of the pipeline.

As described above, the step of creating the damage rate curve according to the present embodiment includes a step of creating the damage rate curve by use of a fitting function.

According to the present embodiment, the damage rate curve can be easily created by use of the calculated data of the second damage rate. Using the damage rate curve created for each type of pipeline makes it possible to more accurately estimate the damage rate of the pipeline.

As described above, the fitting function according to the present embodiment is a sigmoid function.

According to the present embodiment, the damage rate curve can be easily created by use of the calculated data of the second damage rate. Using the damage rate curve created for each type of pipeline makes it possible to more accurately estimate the damage rate of the pipeline.

As described above, the feature amount having high contribution according to the present embodiment is an earthquake motion index.

According to the present embodiment, the damage rate curve can be created by use of an earthquake motion index corresponding to the pipeline characteristic. Using the damage rate curve makes it possible to more accurately estimate the damage rate of the pipeline.

### Second Embodiment

Hereinafter, differences between the first embodiment and the present embodiment will be described.

Since the configuration of the system 1 according to the present embodiment is the same as that of the first embodiment illustrated in FIG. 1, the description thereof will be omitted.

Since the configuration of the damage rate curve creation device 10 according to the present embodiment is the same as that of the first embodiment illustrated in FIG. 2, the description thereof will be omitted.

In the present embodiment, N machine learning models created by the model creation unit 131 of the control unit 13 of the damage rate curve creation device 10 output a “first damage rate” different from the “first damage rate” in the first embodiment. The “first damage rate” in the present embodiment indicates the number of spans damaged by an earthquake among spans belonging to a certain specific section, and is represented by a continuous value of 0 or more. For example, in the present embodiment, the model creation unit 131 creates a machine learning model that outputs the number of damaged spans among spans belonging to a section A.

The curve creation unit 135 of the control unit 13 of the damage rate curve creation device 10 according to the present embodiment calculates a “second damage rate” different from the “second damage rate” in the first embodiment based on second pipeline damage data, and creates a damage rate curve. The “second damage rate” in the present embodiment is represented by a value obtained by dividing the number of records having earthquake damage in the second pipeline damage data by the total extension of extension lengths of spans included in first pipeline damage data. That is, the “second damage rate” in the present embodiment is represented by the number of damaged places per unit length of spans belonging to a certain section. As in the first embodiment, the curve creation unit 135 performs plotting on a plane having the calculated second damage rate on the Y axis and the extreme value specified by the data extraction unit 134 on the X axis. The curve creation unit 135 creates a curve based on the plotting by use of a fitting function to obtain a damage rate curve.

Since the configuration of the damage rate curve application device 20 according to the present embodiment is the same as that of the first embodiment illustrated in FIG. 4, the description thereof will be omitted.

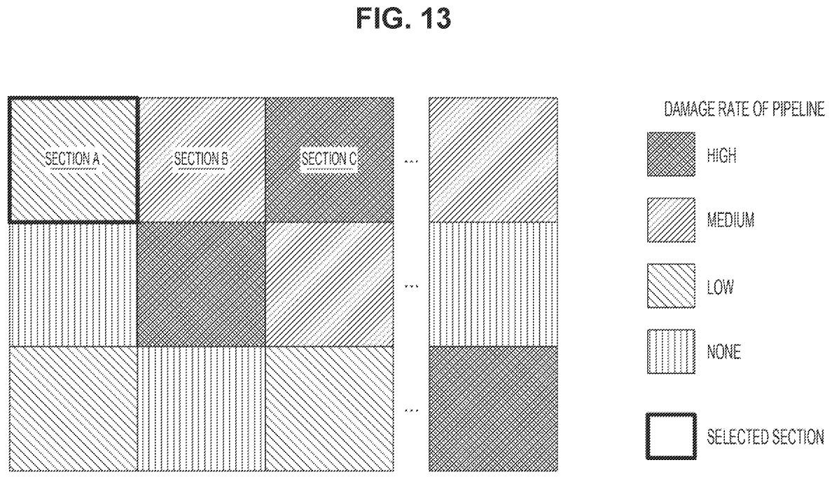

As in the first embodiment, the output unit 24 of the damage rate curve application device 20 according to the present embodiment may represent an estimation result of the damage rate as a numerical value, or may divide numerical values into predetermined ranges and display the estimation result by high, medium, and low levels. The output unit 24 in the present embodiment divides a map into sections to which spans belong, divides the sections into predetermined ranges of the calculated numerical value of the second damage rate, and displays the sections with the colors of the sections changed according to the high, medium, and low levels. An example of display on the output unit 24 in the present embodiment is illustrated in FIG. 13. In FIG. 13, the damage rate for each section on the map is illustrated. Referring to FIG. 13, it can be seen that a damage rate of the section A is low, a damage rate of a section B is medium, and a damage rate of a section C is high. A user can unitarily grasp the damage rate for each section to which spans on the map belong by viewing the display of the output unit 24.

Hereinafter, differences between the operation of the system 1 according to the first embodiment and the operation of the system 1 according to the present embodiment will be described. In the first embodiment, the pipeline characteristic input by the user is the “screw joint steel pipe” or the “adhesive joint vinyl pipe” included in the category of facility information, but in the present embodiment, the pipeline characteristic input by the user is the “section A” or the “section B” included in the category of area information.

First, the operation of the damage rate curve creation device 10 included in the system 1 will be described. This operation corresponds to a damage rate curve creation method according to the present embodiment.

The model creation unit 131 of the damage rate curve creation device 10 acquires records included in the past seismic pipeline damage database 111, puts the records together for each of N pipeline characteristics, and stores the records in the storage unit 11 as first pipeline damage data for creating N machine learning models (step S1). Among the records stored in the past seismic pipeline damage database 111, the model creation unit 131 sets records each having the “section A” as a pipeline characteristic, that is, records of span Nos. 1, 3, and 5 as a set of data, and sets records each having the “section B” as a pipeline characteristic, that is, records of span Nos. 2 and 4 as a set of data, thereby dividing the records by the pipeline characteristics. In this manner, the model creation unit 131 divides the records included in the past seismic pipeline damage database 111 by the pipeline characteristics into N sets. The model creation unit 131 stores each of the sets of data in the storage unit 11 as first pipeline damage data.

Steps S2_1 to S2_N to steps S6_1 to S6_N in FIG. 6A are similar to those in the first embodiment, and thus description thereof will be omitted.

The curve creation unit 135 calculates the second damage rate from the second pipeline damage data (steps S7_1 to S7_N). The curve creation unit 135 calculates the second damage rate by dividing the number of records having earthquake damage in the second pipeline damage data by the total extension of the spans included in the first pipeline damage data having the concerned pipeline characteristic. For example, referring to FIG. 3, among the records of the spans No. 1 and 3 extracted as the second pipeline damage data in step S6_1, the span No. 1 is a record having earthquake damage. Therefore, the curve creation unit 135 divides the number of records having earthquake damage, which include the span No. 1, by the total extension of the spans included in the first pipeline damage data having the “section A” as a pipeline characteristic. In the present embodiment, the number of records having earthquake damage is 10, and the total extension of the spans included in the first pipeline damage data is 4 km. Therefore, the curve creation unit 135 calculates the second damage rate as 2.5 cases/km.

Steps S8_1 to S8_N to step S9 in FIG. 6B are similar to those in the first embodiment, and thus description thereof will be omitted.

Next, the operation of the damage rate curve application device 20 included in the system 1 of the present embodiment will be described.

Steps S10 to S14 in FIG. 11 are similar to those in the first embodiment, and thus description thereof will be omitted.

The output unit 24 displays the estimation result of the damage rate of each span stored in the storage unit 21 to the user (step S15). The output unit 24 displays the damage rate of each span together with map information. FIG. 13 is a display example of estimation results of damage rates in a case where the pipeline characteristic input by the user is the “section A” and the type of earthquake motion index input by the user is the “predicted value”. Referring to FIG. 13, the map is divided into sections, and the damage rates are displayed with the colors of the sections changed according to the damage rate of spans included in each section. The section surrounded by a thick line indicates the position of the “section A”, which is the pipeline characteristic input by the user, on the map.

As described above, in the step of creating the damage rate curves according to the first embodiment and the second embodiment, a rate of the number of damaged pipelines in the second pipeline damage data in the total number of pipelines in the second pipeline damage data or the number of damaged places per unit length of the pipelines in the second pipeline damage data is calculated as the second damage rate.

According to the first embodiment and the second embodiment, the second damage rate used for creating the damage rate curve can be calculated according to a pipeline characteristic. Using the damage rate curve created based on the second damage rate makes it possible to accurately estimate a damage rate of a pipeline.

Although the present disclosure has been described based on the drawings and embodiments, it should be noted that those skilled in the art can easily make various modifications and amendments based on the present disclosure. Therefore, it should be noted that these modifications and amendments are included in the scope of the present disclosure.

As a modification of the present disclosure, the damage rate curve creation device 10 may divide the data of the past seismic pipeline damage database 111 into learning data and verification data, create a machine learning model using the learning data, and then verify the accuracy of the machine learning model using the verification data. The damage rate curve creation device 10 may output the verification result together to the damage rate curve application device 20, and the damage rate curve application device 20 may select a damage rate curve used for estimating a damage rate of a pipeline with reference to the verification result.

### REFERENCE SIGNS LIST

1 System
10 Damage rate curve creation device
11 Storage unit
12 Input unit
13 Control unit
14 Output unit
15 Communication unit
111 Past seismic pipeline damage database
131 Model creation unit
132 Feature amount extraction unit
133 Prediction analysis unit
134 Data extraction unit
135 Curve creation unit
20 Damage rate curve application device
21 Storage unit
22 Input unit
23 Control unit
24 Output unit
25 Communication unit
211 Estimation target pipeline database
212 Earthquake motion index information database
231 Estimation target pipeline acquisition unit
232 Earthquake motion index information acquisition unit
233 Damage rate curve reception unit
234 Estimation unit

1. A damage rate curve creation method comprising:
a step of creating a plurality of machine learning models that predict and output a first damage rate of a pipeline for each pipeline characteristic by use of first pipeline damage data including information on presence or absence of earthquake damage and pipeline characteristics;
a step of extracting a feature amount having high contribution to the prediction for each of the machine learning models;
a step of analyzing a change in the first damage rate related to a change in the feature amount;
a step of specifying a value of the feature amount at an inflection point of the change in the first damage rate as an extreme value, and extracting, from the first pipeline damage data, data having a value of the feature amount at which a difference from the extreme value is equal to or less than a threshold value as second pipeline damage data; and
a step of creating a damage rate curve indicating a second damage rate based on the second pipeline damage data.

2. The damage rate curve creation method according to claim 1, wherein the step of creating the damage rate curve includes a step of creating the damage rate curve by use of a fitting function.

3. The damage rate curve creation method according to claim 2, wherein the fitting function is a sigmoid function.

4. The damage rate curve creation method according to claim 1, wherein the feature amount having high contribution is an earthquake motion index.

5. The damage rate curve creation method according to claim 1, wherein
in the step of creating the damage rate curve,
a rate of the number of damaged pipelines in the second pipeline damage data in the total number of pipelines in the second pipeline damage data or
the number of damaged places per unit length of the pipelines in the second pipeline damage data is calculated as the second damage rate.

6. A damage rate curve creation device comprising:
a model creation unit configured to create a plurality of machine learning models that predict and output a first damage rate of a pipeline for each pipeline characteristic by use of first pipeline damage data including information on presence or absence of earthquake damage and pipeline characteristics;
a feature amount extraction unit configured to extract a feature amount having high contribution to the prediction for each of the machine learning models;
a prediction analysis unit configured to analyze a change in the first damage rate related to a change in the feature amount;
a data extraction unit configured to specify a value of the feature amount at an inflection point of the change in the first damage rate as an extreme value, and extract, from the first pipeline damage data, data having a value of the feature amount at which a difference from the extreme value is equal to or less than a threshold value as second pipeline damage data; and
a curve creation unit configured to create a damage rate curve indicating a second damage rate based on the second pipeline damage data.

7. The damage rate curve creation device according to claim 6, wherein the curve creation unit creates the damage rate curve by use of a fitting function.

8. A program for causing a computer to function as the damage rate curve creation device according to claim 6.
